(19) United States
(12) Patent Application Publication
(10) Pub. No.: US 2002/0153478 A1
(43) Pub. Date: Oct. 24, 2002

(54) Method of preventing cross talk

(76) Inventor: Chih-Hsing Hsin, Chu-Pei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/836,260

(22) Filed: Apr. 18, 2001

(51) Int. Cl. G01J 1/04

(52) U.S. Cl. 250/227.14

(57) ABSTRACT

The present invention provides a method for preventing cross-talk of incident light in a photosensor device. The photosensor device is formed on the substrate of a semiconductor wafer and comprises a plurality of MOS transistor sensors. The present invention first involves forming a dielectric layer on the semiconductor wafer, which covers each MOS transistor sensor. Thereafter, a plurality of shallow trenches are formed in the dielectric layer, followed by the formation of a barrier layer on the surface of the dielectric layer and on the inner surface of each shallow trench. Then, a metal layer is formed on the surface of the barrier layer and fills each shallow trench. Finally, a chemical mechanical polishing (CMP) process is performed to remove both the barrier layer and the metal layer from each shallow trench. The metal layer in each shallow trench is used to prevent cross-talk from occurring in each MOS transistor sensor in the photosensor device.

### 1. FIELD OF THE INVENTION

The present invention relates to a method of manufacturing a photosensor device, and more particularly, to a method of preventing cross-talk of incident light in the photosensor device.

### 2. DESCRIPTION OF THE PRIOR ART

Charge-coupled devices (CCDs) have been the mainstay of conventional imaging circuits for converting light into an electrical signal. The applications of CCDs include monitors, transcription machines and cameras. Although CCDs have many advantages, CCDs also suffer from high costs and the limitations imposed by its volume. To overcome the weakness of CCDs and reduce costs and dimensions, a CMOS photodiode device is developed. Since a CMOS photodiode device can be produced by using conventional techniques, both cost and the volume of the sensor can be reduced. The applications of CMOS photodiodes include PC cameras, digital cameras etc.

The photodiode is based on the theory that a P-N junction can convert light into an electrical signal. Before energy in the form of photons strikes the photodiode, there is an electric field in the P-N junction. The electrons in the N region do not diffuse forward to the P region and the holes in the P region do not diffuse forward to the N region. When enough light strikes the photodiodes, the light creates a number of electron-hole pairs. The electrons and the holes diffuse forward to the P-N junction, as a result of the effect of the inner electric field across the junction, the electrons flow to the N region and the holes flow to the P region. Thus, a current is induced between the P-N junction electrodes. The energy of the incident light can be determined by measuring the induced current so as to convert light into an electrical signal.

Please refer to FIG. 1 to FIG. 4. FIG. 1 to FIG. 4 are cross-sectional diagrams of manufacturing a photosensor device on a semiconductor wafer 10 according to the prior art method. As shown in FIG. 1, the semiconductor wafer 10 contains a silicon substrate 12 and a P-well 14 positioned on the silicon substrate 12. The photosensor device contains a plurality of CMOS photodiodes and each photodiode contains a metal-oxide semiconductor (MOS) transistor (not shown) positioned on the P-well 14 and a photo sensor area 18 formed on the P-well 14 which electrically connects with the MOS transistor. The MOS transistor is a complementary metal-oxide semiconductor (CMOS) transistor composed of an NMOS transistor and a PMOS transistor and functions as a CMOS transistor sensor. The semiconductor wafer 10 also contains a plurality of field oxide layers or shallow trench isolation (STI) structures 16 positioned on the silicon substrate 12 and surrounding the photo sensor area 18. The STI structures 16 act as a dielectric insulating material to prevent short circuiting due to contact between the photo sensor areas 18 and other units.

The method of manufacturing a photosensor device according to the prior art first involves forming a passivation layer 20 on the surface of the semiconductor wafer 10 to cover each photo sensor area 18. Next, as shown in FIG. 2, red, blue and green color filters 22 are respectively formed on the passivation layer 20, and each color filter 22 is positioned above a corresponding photo sensor area 18. As shown in FIG. 3, an interlayer 24 is formed on the surface of the color filters 22, followed by the formation of a polymer layer 26 composed of acrylate material above the interlayer 24. Then, an exposure and development process is used to form patterns of U-lenses in the polymer layer 26. Finally, as shown in FIG. 4, by annealing the lens patterns, U-lenses 28 corresponding to each photo sensor area 18 are formed.

The light-induced current of the photodiode represents a signal, whereas the current present in the absence of light represents noise. The photodiode processes signal data by using the magnitude of the signal-to-noise ratio. In the semiconductor industry, it is often desirable to increase the light-induced current of the photodiode so as to increase the signal-to-noise ratio, and hence to enhance the contrast of the signal. As well, sensitivity of the photodiode is enhanced and the quality of the photodiode is improved. However, as the resolution of the photosensor device increases, the dimension of the CMOS transistor sensor in the photosensor device correspondingly decreases. As a result, the U-lens cannot completely focus the incident light onto the photo sensor area, therefore, the scattered light radiate into the neighboring photo sensor area in the photosensor device produced by the prior art method to result in cross-talk. Moreover, the contrast of the signal cannot be enhanced and the sensitivity of the photosensor device is influenced.

### SUMMARY OF THE INVENTION

It is therefore a primary objective of the present invention to provide a method of manufacturing a photosensor device for preventing cross-talk of incident light in the photosensor device and for enhancing the magnitude of the signal-to-noise ratio of the photosensor device.

The present invention provides a method for preventing cross-talk of incident light in a photosensor device. The photosensor device is formed on the substrate of a semiconductor wafer and a plurality of MOS transistor sensors are positioned on the substrate. A plurality of insulators are respectively formed between two MOS transistor sensors on the substrate. The present invention first involves forming a dielectric layer on the semiconductor wafer, which covers each MOS transistor sensor and the insulator. Thereafter, a plurality of shallow trenches are formed in the dielectric layer followed by the formation of a barrier layer on the surface of the dielectric layer and on the inner surface of each shallow trench. Then, a metal layer is formed on the surface of the barrier layer and fills each shallow trench. Finally, a chemical mechanical polishing (CMP) process is performed to remove both the barrier layer and the metal layer from each shallow trench. The metal layer in each shallow trench is used to prevent cross-talk from occurring in each MOS transistor sensor in the photosensor device.

The photosensor device manufactured by the present invention forms a metal shield between each photo sensor area so as to prevent scattered light from radiating into neighboring photo sensor areas to result in cross-talk. As well, the metal shield reflects the scattered light into the photo sensor area so as to enhance the sensitivity.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 to FIG. 4 are cross-sectional diagrams of manufacturing a photosensor device according to the prior art method.

FIG. 5 to FIG. 10 are cross-sectional diagrams of manufacturing a photosensor device by the present invention method.

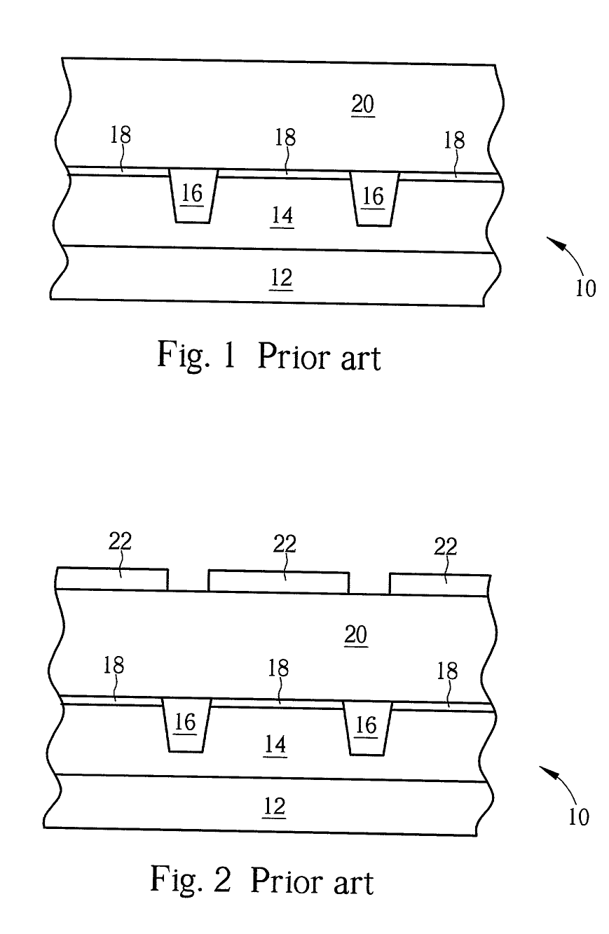

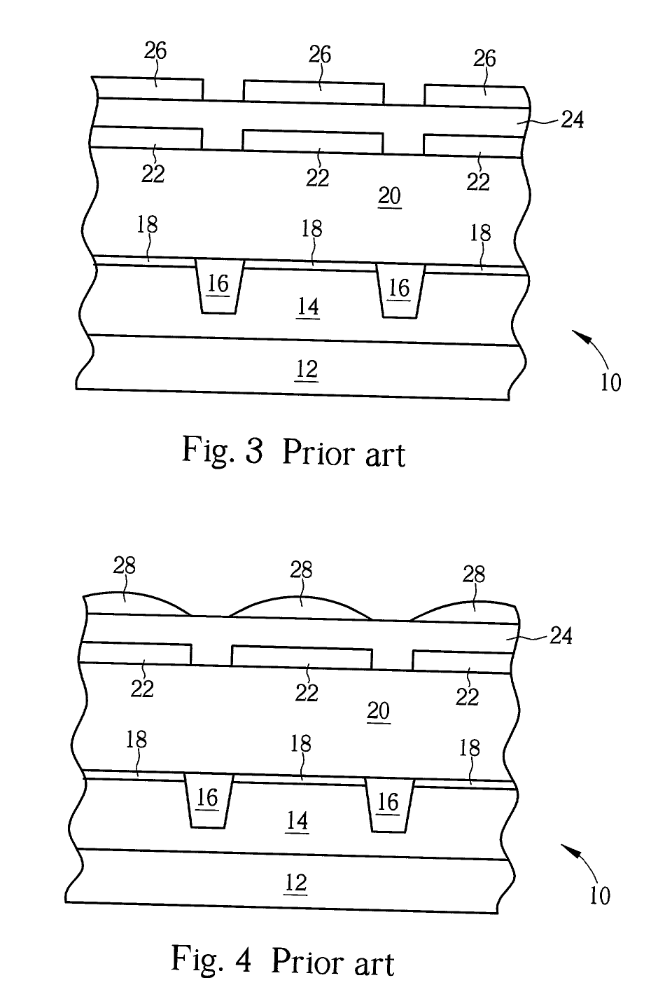

### DETAILED DESCRIPTION OF THE PREFERRED EMBODIMENT

Please refer to FIG. 5 to FIG. 10. FIG. 5 to FIG. 10 are cross-sectional diagrams of manufacturing a photosensor device by the present invention method. As shown in FIG. 5, the semiconductor wafer 60 contains a silicon substrate 62 and a P-well 64 positioned on the silicon substrate 62. The photosensor device contains a plurality of CMOS photodiodes and each photodiode contains both a metal-oxide semiconductor (MOS) transistor (not shown) positioned on the P-well 64 and a photo sensor area 68 formed on the P-well 14 which electrically connects with the MOS transistor. The MOS transistor is a complementary metal-oxide semiconductor (CMOS) transistor composed of an NMOS transistor and a PMOS transistor and functions as a CMOS transistor sensor. The semiconductor wafer 60 also contains a plurality of field oxide layers or shallow trench isolation (STI) structures 66 positioned on the silicon substrate 62 and surrounding the photo sensor area 68. The STI structures 66 act as a dielectric insulating material to prevent short circuiting due to contact between the photo sensor areas 68 and other units.

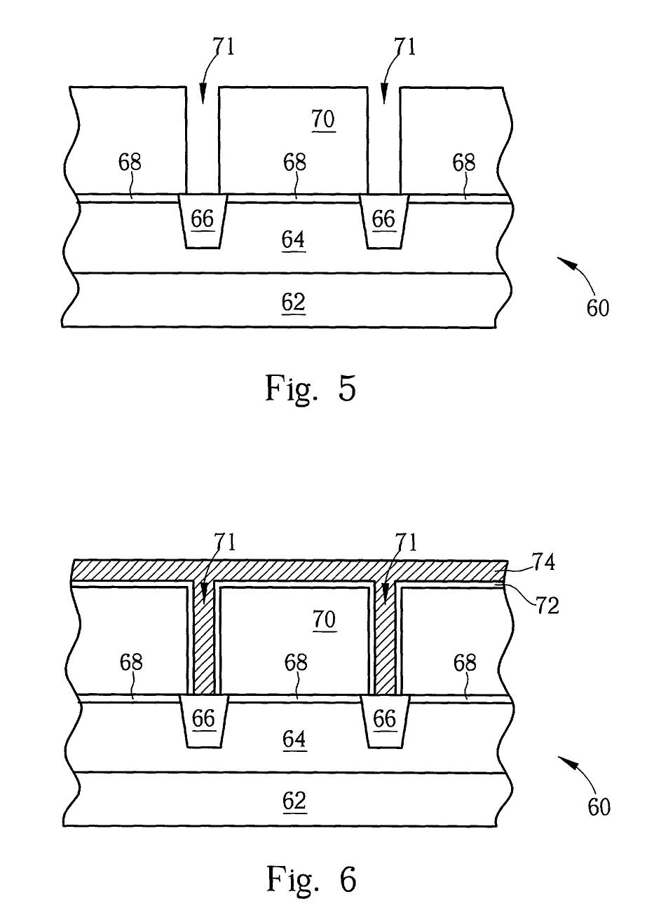

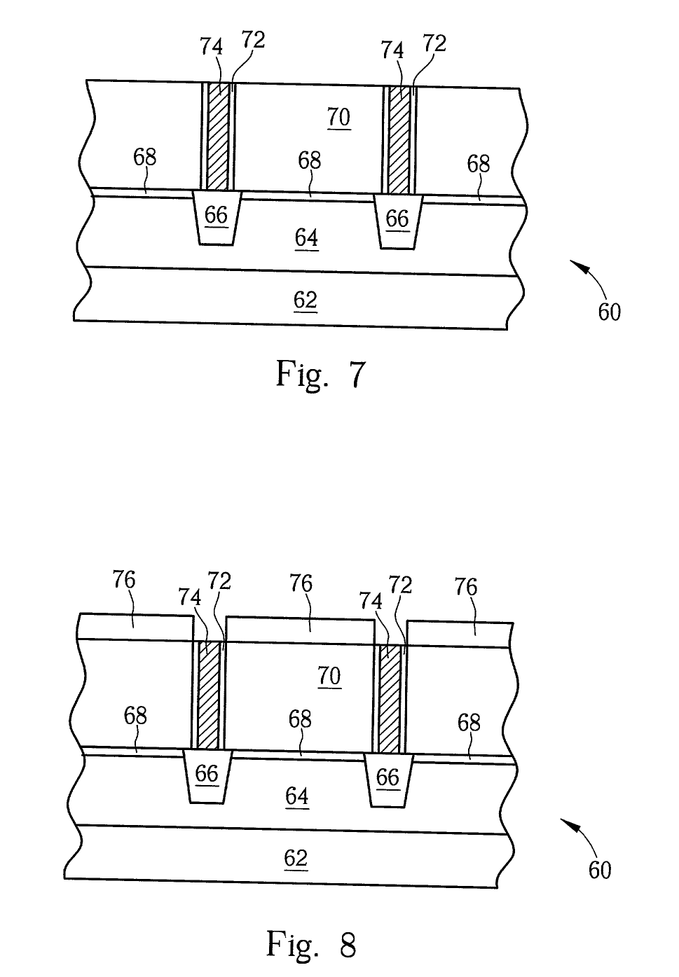

Firstly, a dielectric layer 70 is formed on the semiconductor wafer 60 and functions as a passivation layer covering the MOS transistor and shallow trench isolation structure 66. A plurality of shallow trenches 71 are formed in the dielectric layer 70 which extends from the surface of the dielectric layer 70 down to the surface of each shallow trench isolation structure 66. Next, as shown in FIG. 6, a barrier layer or glue layer 72 composed of titanium nitride or titanium is formed on the surface of the dielectric layer 70 and on the inner surface of each shallow trench 71, followed by the formation of a metal layer 74 composed of titanium, titanium nitride or tungsten which fills each shallow trench 71. Thereafter, as shown in FIG. 7, a chemical mechanical polishing (CMP) process is performed to remove the barrier layer or glue layer 72 and metal layer 74 outside the shallow trenches 71. The metal layer 74 is used to reflect scattered light so as to prevent cross-talk. Also, the metal layer 74 can be replaced by a photo-absorb layer (not shown) so as to absorb the scattered light and prevent cross-talk.

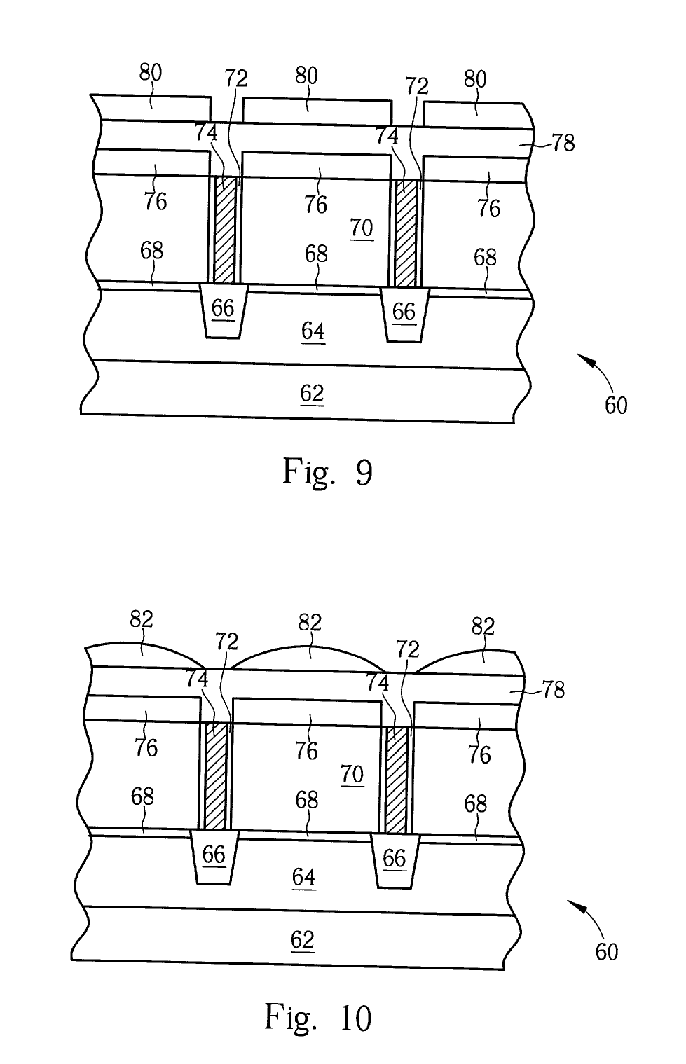

After the CMP process, both a color filter layer and a U-lens are formed using a prior art method. As shown in FIG. 8, red, blue and green color filters 76 are respectively formed on the dielectric layer 70 and each color filter 76 is positioned above a corresponding photo sensor area 68. As shown in FIG. 9, an interlayer 78 is formed on the surface of the color filters 76, followed by the formation of a polymer layer 80 composed of acrylate material on the interlayer 78. Then, an exposure and development process is used to form patterns of U-lenses in the polymer layer 80. Finally, as shown in FIG. 10, by annealing the lens patterns, U-lenses 82 corresponding to each photo sensor area 68 are formed.

Since the dimension of the CMOS transistor sensor in the photosensor device gradually decreases, the U-lens cannot completely focus the incident light onto the photo sensor area so that the scattered light radiates into the neighboring photo sensor area in the photosensor device produced by the prior art method to result in cross-talk. The present invention method of manufacturing a photosensor device first involves sequentially forming CMOS transistor sensors and a dielectric layer on the semiconductor wafer, then a shield is formed between each neighboring photosensor area in the dielectric layer. Therefore, the shield reflects or absorbs the scattered light not focused onto the photo sensor area so as to enhance the sensitivity and prevent cross-talk from occurring in the photosensor device.

In contrast to the photosensor device produced by the prior art method, the photosensor device produced by the present invention uses a shield to prevent the scattered light from radiating into neighboring photo sensor areas to result in cross-talk. Furthermore, the magnitude of the signal-to-noise ratio is enhanced and the sensitivity of the photosensor device is improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of preventing cross talk of light in an optic sensor apparatus, the optic sensor apparatus being formed on a semiconductor wafer, the semiconductor wafer comprising a substrate, a plurality of metal-oxide semiconductor (MOS) transistor sensors positioned on the substrate, and a plurality of insulators positioned on the substrate, and each insulator positioned between each two MOS transistor sensors, the method comprising:
forming a dielectric layer on the semiconductor wafer covering the MOS transistor sensors and the insulators;
forming a plurality of trenches in the dielectric layer, each trench being through the surface of the dielectric layer to the surface of each of the insulator;
forming a barrier layer covering the surface of the dielectric layer, the walls within the trenches, and the bottoms within the trenches;
forming a metal layer on the barrier layer, and filling the trenches; and
performing a chemical mechanical polishing (CMP) process to remove both portions of the barrier layer and portions of the metal layer outside the trenches;
wherein the metal layer within the trenches is used to prevent cross talk of light in the optic sensor apparatus.

2. The method of claim 1 wherein the MOS transistor sensors are complementary metal-oxide semiconductor (CMOS) transistor sensors.

3. The method of claim 1 wherein the insulators are field oxides (FOX) or shallow trench isolations (STI).

4. The method of claim 1 wherein the barrier layer is composed of titanium nitride (TiN).

5. The method of claim 1 wherein the metal layer is composed of titanium (Ti).

6. The method of claim 1 wherein the method further comprises a process for forming a color filter layer and a process for forming a U-lens, following the CMP process.

7. A method of preventing cross talk of light in an optic sensor apparatus, the optic sensor apparatus being formed on a semiconductor wafer, the semiconductor wafer comprising a substrate, a plurality of metal-oxide semiconductor (MOS) transistor sensors positioned on the substrate, and a plurality of insulators positioned on the substrate, each insulator positioned between each two MOS transistor sensors, the method comprising:
forming a dielectric layer on the semiconductor wafer covering the MOS transistor sensors and the insulators;
forming a plurality of trenches in the dielectric layer, each trench being through the surface of the dielectric layer to the surface of each of the insulator; and
forming a barrier layer within the trenches;
wherein the barrier layer within the trenches is used to prevent cross talk of light in the optic sensor apparatus.

8. The method of claim 7 wherein the MOS transistor sensors are complementary metal-oxide semiconductor (CMOS) transistor sensors.

9. The method of claim 7 wherein the insulators are field oxides (FOX) or shallow trench isolations (STI).

10. The method of claim 7 wherein the barrier layer is a reflective layer, and is used to reflect light so as to prevent cross talk of light.

11. The method of claim 10 wherein the metal layer is composed of titanium (Ti).

12. The method of claim 7 wherein the barrier layer is a absorbable layer, and is used to absorb light so as to prevent cross talk of light.

13. The method of claim 12 wherein the barrier layer is composed of titanium nitride (TiN).

14. The method of claim 7 wherein the method further comprises a process for forming a color filter layer and a process for forming a U-lens, following the CMP process.
